(19) United States
(12) Patent Application Publication
(10) Pub. No.: US 2023/0247724 A1
(43) Pub. Date: Aug. 3, 2023

(54) HEATER SYSTEM FOR VEHICLE, SENSOR MODULE FOR VEHICLE, AND VEHICLE

(71) Applicant: TOYOTA JIDOSHA KABUSHIKI KAISHA, Toyota-shi (JP)

(72) Inventor: Takayuki MASHIMO, Toyota-shi (JP)

(73) Assignee: TOYOTA JIDOSHA KABUSHIKI KAISHA, Toyota-shi (JP)

(21) Appl. No.: 18/089,846

(22) Filed: Dec. 28, 2022

(30) Foreign Application Priority Data
Feb. 1, 2022 (JP) 2022-014067

(51) Int. Cl. H05B 1/02; B60H 1/00; H05B 3/00

(52) U.S. Cl. CPC H05B 1/0236; B60H 1/00735; H05B 3/0019

(57) ABSTRACT

Provided is a heater system (20) including: a temperature sensor configured to detect an outside temperature (T); an electric heater configured to heat one of a predetermined portion of an exterior part of a vehicle (V), the predetermined portion being a portion in which an in-vehicle sensor different from the temperature sensor is placed, or a surrounding portion of the predetermined portion; and a control device configured to control power to be supplied to the electric heater based on a result of detection by the temperature sensor. The control device is configured to start power supply to the electric heater when the outside temperature (T) is equal to or higher than a predetermined first temperature (T1) and equal to or lower than a second temperature (T2), which is higher than the first temperature, start, when the outside temperature (T) exceeds the second temperature (T2) during the power supply to the electric heater, measurement of a duration time (t) for which the outside temperature (T) remains above the second temperature (T2), and stop the power supply to the electric heater when the duration time (t) exceeds a predetermined threshold value (tth).

### BACKGROUND OF THE INVENTION

### 1. Field of the Invention

The present invention relates to a heater system for a vehicle, which is mounted on a vehicle to heat a predetermined portion of an exterior part of the vehicle and thereby melt snow adhering to the predetermined portion, a sensor module for a vehicle including the heater system for a vehicle, and a vehicle including the heater system for a vehicle.

### 2. Description of the Related Art

Hitherto, there has been known a radar device mounted on a vehicle to recognize objects (another vehicle, a pedestrian, a curbstone, a guardrail, and the like) present around the vehicle. The radar device includes, for example, a transmission device, a reception device, and a control device. The transmission device transmits a radio wave (millimeter wave). The radio wave is propagated from an opening portion (window) formed in an exterior part of the vehicle to outside of the vehicle. The propagated radio wave is reflected by an object present around the vehicle, and a reflected wave thereof is propagated from the opening portion to inside of the exterior part. The reception device receives the reflected wave, and outputs a signal representing the reflected wave (a reflected wave signal). The control device calculates (recognizes) a relative position of the object present around the vehicle that is relative to the vehicle, a shape of the object, and the like, based on the reflected wave signal.

The above-mentioned opening portion is provided with a cover through which the radio wave is transmissible. When fallen snow adheres to the cover, the radio wave transmitted from the transmission device is reflected by the snow adhering to the cover. Consequently, the control device cannot recognize an object with accuracy. An example of solutions that have been proposed is a heater system for a vehicle (hereinafter referred to as “related-art system”) for melting snow adhering to the cover so that melted snow runs down the cover (see, for example, Japanese Patent Application Laid-open No. 2020-030908).

The related-art system includes an electric heater (a heating wire), a power supply device, and a control device. The control device controls the power supply device so that, when an outside temperature is within a predetermined temperature range, power is supplied to the electric heater. There is a case in which the outside temperature (a temperature around a vehicle) rises relatively rapidly when, for example, the vehicle enters a tunnel during snowfall. When the outside temperature exceeds an upper limit of the predetermined temperature range in this state, the control device of the related-art system immediately stops power supply to the electric heater. In that case, if there is snow remaining on the cover, there is a fear in that the control device of the radar device for a vehicle cannot recognize an object with accuracy in the tunnel. There is also a case in which, when snow adhering to the cover is not completely melted and remains in the form of water drops, and the outside temperature rapidly declines after the vehicle exits the tunnel, the water drops freeze. That is, now ice adheres to the cover. This is another situation in which the control device of the radar device for a vehicle may fail to recognize an object with accuracy. As described above, when the related-art system is employed, performance of an in-vehicle sensor may temporarily decrease (the in-vehicle sensor may temporarily lose ability to accurately detect a physical quantity of a detection target) during snowfall.

### SUMMARY OF THE INVENTION

It is an object of the present invention to provide a heater system for a vehicle capable of suppressing a decrease in performance of an in-vehicle sensor during snowfall.

In order to solve the above-mentioned problem, according to at least one embodiment of the present invention, there is provided a heater system (20) for a vehicle, including: a temperature sensor (23) configured to detect an outside temperature (T); an electric heater (21) configured to heat one of a predetermined portion of an exterior part of a vehicle, the predetermined portion being a portion in which an in-vehicle sensor (10) different from the temperature sensor is placed, or a surrounding portion (EM) of the predetermined portion; and a control device (CPU) configured to control power to be supplied to the electric heater based on a result of detection by the temperature sensor. The control device is configured to start power supply to the electric heater when the outside temperature is equal to or higher than a predetermined first temperature (T1) and equal to or lower than a second temperature (T2), which is higher than the predetermined first temperature, start, when the outside temperature exceeds the second temperature during the power supply to the electric heater, measurement of a duration time (t) for which the outside temperature remains above the second temperature, and stop the power supply to the electric heater when the duration time exceeds a predetermined threshold value (tth).

As described above, according to the heater system for a vehicle of the at least one embodiment of the present invention, power is supplied to the electric heater when the outside temperature is within a predetermined temperature range (equal to or higher than a lower limit value and equal to or lower than an upper limit value). That is, a predetermined portion of the exterior part or a surrounding portion of the predetermined portion (hereinafter simply referred to as “exterior part”) is heated. Consequently, snow that adheres to a surface of the exterior part when the outside temperature is within this temperature range melts in a relatively short time and runs down. This suppresses impairment of a function (hindrance to delivery of full performance) of the in-vehicle sensor. When the outside temperature exceeds the above-mentioned upper limit value during the heating of the exterior part, and a time for which this state lasts exceeds a threshold value, the heating of the exterior part is stopped. That is, instead of stopping the heating of the exterior part as soon as the outside temperature exceeds the upper limit value, a state in which the exterior part is heated is maintained for a while. In that time, the snow adhering to the exterior part melts and runs down. This prevents the snow from remaining in the portion when the outside temperature temporarily rises and exceeds the upper limit value. That is, impairment of the function (hindrance to delivery of full performance) of the in-vehicle sensor can be suppressed.

In the heater system for a vehicle according to one aspect of the present invention, the electric heater includes a heating wire (21), the heating wire is incorporated in a cover member (EM) configured to cover the in-vehicle sensor, and one of a length of time required to melt, with the electric heater, all of adhering snow from a state in which the outside temperature matches the second temperature and snow adheres to an entire surface of the cover member, or a time longer than the required length of time, is set as the predetermined threshold value.

With this configuration, all of the snow adhering to the cover member can be melted without fail in a state in which the outside temperature temporarily exceeds the upper limit value.

In the heater system for a vehicle according to another aspect of the present invention, the in-vehicle sensor includes antennas (112, 121) configured to transmit and receive radio waves, and the cover member is transmissive of the radio waves, and is attached to an opening portion formed in the exterior part.

With this configuration, a decrease in performance of the radar device during snowfall can be suppressed.

Further, according to one aspect of the present invention, there is provided a sensor module for a vehicle, including the above-mentioned heater system for a vehicle.

Further, according to another aspect of the present invention, there is provided a vehicle including the above-mentioned heater system for a vehicle.

In the description given above, in order to facilitate understanding of the present invention, components of the invention corresponding to at least one embodiment described later are accompanied by parenthesized reference symbols used in the at least one embodiment. However, components of the present invention are not limited to those in the at least one embodiment that are specified by the reference symbols.

### BRIEF DESCRIPTION OF THE DRAWINGS

FIG. 1 is a front view for illustrating a front of a vehicle to which a heater system for a vehicle according to at least one embodiment of the present invention is applied.

FIG. 2 is a block diagram of a radar module to which the heater system for a vehicle is applied.

FIG. 3 is a flow chart of a heating starting program.

FIG. 4 is a flow chart of a heating stopping program.

### DESCRIPTION OF THE EMBODIMENTS

(Overview)

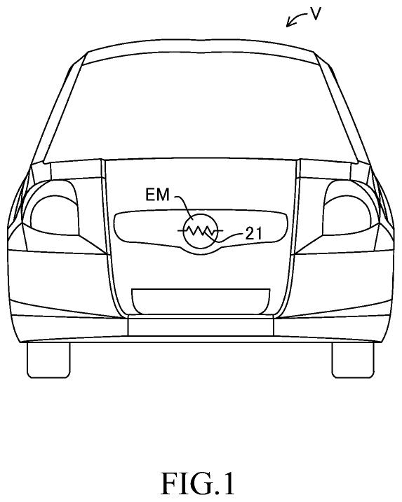

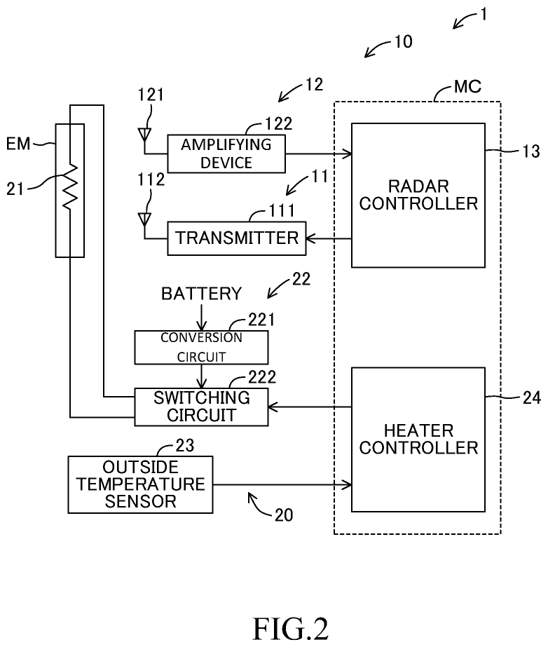

As illustrated in FIG. 1 and FIG. 2, a radar module 1 includes, in addition to a radar system 10, a heater system 20 for a vehicle (hereinafter referred to as “heater system 20”) according to at least one embodiment of the present invention. The radar module 1 is provided in a front end portion of a vehicle V. The radar module 1 recognizes an object ahead of the vehicle V.

### (Specific Configuration)

The radar system 10 includes a transmission device 11, a reception device 12, and a radar controller 13.

The transmission device 11 includes a transmitter 111 and a transmission antenna 112. The transmitter 111 is a signal source for outputting a predetermined signal. The transmission antenna 112 is placed behind an emblem EM provided in a central portion of a front grill of the vehicle V. The emblem EM is formed of a synthetic resin material transmissive of radio waves (millimeter waves). The emblem EM is fitted into an opening portion formed in the front grill of the vehicle V. The transmission antenna 112 emits (transmits), as a radio wave in a millimeter waveband, the signal output from the transmitter 111. The millimeter wave transmitted from the transmission antenna 112 is propagated through the emblem EM to outside of a vehicle body of the vehicle V (forward). This millimeter wave is reflected by an object (a three-dimensional object). The millimeter wave reflected by the object (a reflected wave) is propagated toward the vehicle V. The reflected wave is propagated through the emblem EM to an interior of the vehicle body.

The reception device 12 includes a reception antenna 121 and an amplifying device 122. The reception antenna 121 is placed behind the emblem EM. The reception antenna 121 receives the reflected wave from the object, and outputs a reflected wave signal representing the reflected wave.

The amplifying device 122 amplifies the reflected wave signal and supplies the amplified signal to the radar controller 13.

The radar controller 13 controls the transmission device 11 so that the transmission device 11 emits (transmits) the millimeter wave. The radar controller 13 also acquires the reflected wave signal from the reception device 12. The radar controller 13 calculates a phase difference between the transmitted millimeter wave and the received reflected wave (reflected wave signal), an attenuation level of the reflected wave, a length of time from the transmission of the millimeter wave to the reception of the reflected wave, and the like. The radar controller 13 acquires, based on results of the calculation, information indicating a distance between the vehicle V and the three-dimensional object, a relative speed of the vehicle V relative to the three-dimensional object, a relative position (direction) of the three-dimensional object relative to the vehicle V, and the like. The radar controller 13 transmits the information via a communication network (CAN) (not shown) to another device (for example, a control device (ECU) for controlling behavior of the vehicle V).

The heater system 20 includes a heating wire 21, a power supply circuit 22, an outside temperature sensor 23, and a heater controller 24.

The heating wire 21 includes a heat generation portion which generates heat when power is supplied to (when a current is caused to flow in) the heat generation portion. The heat generation portion is embedded in the emblem EM with use of insert molding. The emblem EM can be heated by supplying power to the heating wire 21.

The power supply circuit 22 includes, among others, a conversion circuit 221 for converting power that is supplied from a battery of the vehicle V into power that is to be supplied to the heating wire, and a switching circuit 222 for shutting off power supply from the conversion circuit 221 to the heating wire 21.

The outside temperature sensor 23 is placed below the emblem EM. The outside temperature sensor 23 detects an outside temperature T, and supplies a result of the detection to the heater controller 24.

The heater controller 24 controls an on state and an off state of the switching circuit 222 based on the outside temperature acquired from the outside temperature sensor 23.

Functions of the radar controller 13 and the heater controller 24 are implemented by one microcomputer MC. That is, the microcomputer MC includes, among others, an arithmetic device (hereinafter referred to as “CPU”), a storage device (a RAM, a ROM, and the like), and a communication device. The CPU executes a computer program stored in advance in the storage device, to thereby control the transmission device 11, the switching circuit 222, and others. However, two microcomputers for implementing the function of the radar controller 13 and the function of the heater controller 24, respectively, may be provided.

### (Operation)

Operation of the heater system 20 (heater controller 24) is described next. When the vehicle V is activated (when an engine is started), the heater controller 24 acquires the outside temperature T from the outside temperature sensor 23 in predetermined cycles to recognize the outside temperature T and changes in outside temperature T.

When the acquired outside temperature T is equal to or higher than a lower limit value T1 (for example, −5° C.) and equal to or lower than an upper limit value T2 (+5° C.), the heater controller 24 controls the power supply circuit 22 so that the power supply circuit 22 supplies power to the heating wire 21. That is, the heater controller 24 causes the switching circuit 222 to shift from the off state to the on state, to thereby heat the emblem EM. In a case in which the switching circuit 222 is already in the on state, the heater controller 24 keeps the switching circuit 222 in the on state.

In a case of a shift from a state in which the outside temperature T is equal to or higher than the lower limit value T1 to a state in which the outside temperature T is lower than the lower limit value T1, the heater controller 24 controls the power supply circuit 22 so that the power supply circuit 22 stops the power supply to the heating wire 21. That is, the heater controller 24 causes the switching circuit 222 to shift from the on state to the off state.

When a state in which the outside temperature T is equal to or lower than the upper limit value T2 shifts to a state in which the outside temperature T is higher than the upper limit value T2, the heater controller 24 starts, at that point, measurement of a duration time “t” indicating how long the state in which the outside temperature T is higher than the upper limit value T2 lasts. When the duration time “t” exceeds a predetermined threshold value tth (for example, 10 seconds), the heater controller 24 controls the power supply circuit 22 so that the power supply circuit 22 stops the power supply to the heating wire 21. That is, the heater controller 24 causes the switching circuit 222 to shift from the on state to the off state. In a case in which the outside temperature T shifts to a temperature equal to or lower than the upper limit value T2 before the duration time “t” exceeds the threshold value tth, the heater controller 24 does not stop the power supply to the heating wire 21. That is, the heater controller 24 continues the heating of the emblem EM.

A length of time required to melt, with the heating wire 21, all of adhering snow from a state in which the outside temperature T matches the upper limit value T2 and snow adheres to an entire surface of the emblem EM, or a time longer than the required length of time, is set as the threshold value tth.

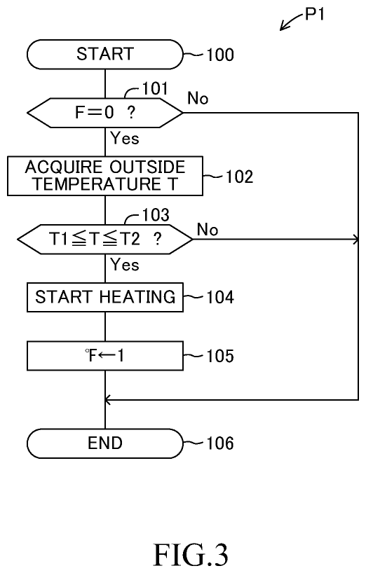

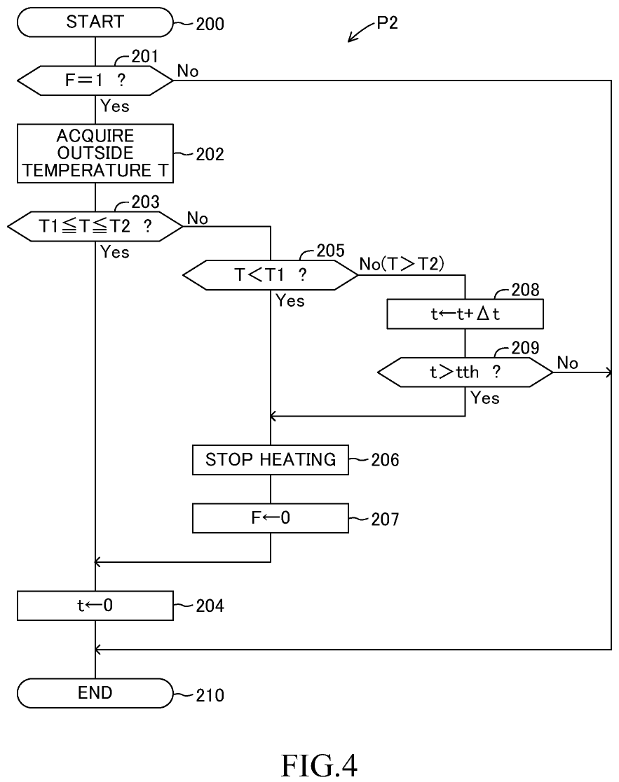

Next, a specific description is given with reference to FIG. 3 and FIG. 4 about the operation (a heating starting program P1 and a heating stopping program P2 which implement start and stop, respectively, of heating of the emblem EM) of the heater controller 24 (hereinafter simply referred to as “CPU”). When the vehicle V is activated (when the engine is started), the CPU executes the heating starting program P1 and the heating stopping program P2 in predetermined cycles (each time a predetermined micro time Δt elapses). A flag F is used in both of the programs. The flag F indicates whether the emblem EM is being heated (whether power is being supplied to the heating wire 21). A value “1” of the flag F indicates that the emblem EM is being heated, and a value “0” of the flag F indicates that the emblem EM is not being heated. The flag F is initialized to “0” when the engine of the vehicle V is activated.

### (Heating Starting Program P1)

The CPU starts execution of heating starting processing from Step 100, and the process then proceeds to Step 101.

In Step 101, the CPU determines whether the value of the flag F is “0.” When the flag F is “0” (Step 101: “Yes”), the process proceeds to Step 102. When the flag F is “1” (Step 101: “No”), on the other hand, the process proceeds to Step 106, in which the CPU ends the heating starting processing.

In Step 102, the CPU acquires the outside temperature T from the outside temperature sensor 23. The process then proceeds to Step 103.

In Step 103, the CPU determines whether the outside temperature T is “equal to or higher than the lower limit value T1 and equal to or lower than the upper limit value T2.” When the outside temperature T is “equal to or higher than the lower limit value T1 and equal to or lower than the upper limit value T2” (Step 103: “Yes”), the process proceeds to Step 104. When the outside temperature T is lower than the lower limit value T1, or higher than the upper limit value T2 (Step 103: “No”), on the other hand, the process proceeds to Step 106.

In Step 104, the CPU starts heating of the emblem EM. That is, the CPU causes the switching circuit 222 to start power supply to the heating wire 21. The process then proceeds to Step 105.

In Step 105, the CPU sets the flag F to “1,” and the process proceeds to Step 106.

### (Heating Stopping Program P2)

The CPU starts execution of heating stopping processing from Step 200, and the process proceeds to Step 201.

In Step 201, the CPU determines whether the value of the flag F is “1.” When the flag F is “1” (Step 201: “Yes”), the process proceeds to Step 202. When the flag F is “0” (Step 201: “No”), on the other hand, the process proceeds to Step 210, in which the CPU ends the heating stopping processing.

In Step 202, the CPU acquires the outside temperature T from the outside temperature sensor 23. The process then proceeds to Step 203.

In Step 203, the CPU determines whether the outside temperature T is “equal to or higher than the lower limit value T1 and equal to or lower than the upper limit value T2.” When the outside temperature T is “equal to or higher than the lower limit value T1 and equal to or lower than the upper limit value T2” (Step 203: “Yes”), the process proceeds to Step 204. When the outside temperature T is lower than the lower limit value T1, or higher than the upper limit value T2 (Step 203: “No”), on the other hand, the process proceeds to Step 205.

In Step 204, the CPU initializes the duration time “t” (a length of time for which the outside temperature T remains above the upper limit value T2) to “0.” The process then proceeds to Step 210, in which the CPU ends the heating stopping processing.

In Step 205, the CPU determines whether the outside temperature T is lower than the lower limit value T1. When the outside temperature T is lower than the lower limit value T1 (Step 205: “Yes”), the process proceeds to Step 206. When the outside temperature T is higher than the upper limit value T2 (Step 205: “No”), on the other hand, the process proceeds to Step 208.

In Step 206, the CPU stops the heating of the emblem EM. That is, the CPU causes the switching circuit 222 to stop the power supply to the heating wire 21. The process then proceeds to Step 207.

In Step 207, the CPU sets the flag F to “0,” and the process proceeds to Step 204.

In Step 208, the CPU updates the duration time “t.” That is, the CPU adds the micro time Δt to the duration time “t.” The process then proceeds to Step 209.

In Step 209, the CPU determines whether the duration time “t” exceeds the predetermined threshold value tth. When it is determined that the duration time “t” exceeds the threshold value tth (Step 209: “Yes”), the process proceeds to Step 206. When the duration time “t” is equal to or lower than the threshold value tth (Step 209: “No”), on the other hand, the process proceeds to Step 210.

### (Effects)

As described above, according to the heater system 20, the emblem EM is heated when the outside temperature T is within the predetermined temperature range (equal to or higher than the lower limit value T1 and equal to or lower than the upper limit value T2). Consequently, snow that adheres to the surface of the emblem EM when the outside temperature T is within this temperature range melts in a relatively short time and runs down. This suppresses impairment of the function (hindrance to delivery of full performance) of the radar system 10. When the outside temperature T exceeds the upper limit value T2 during the heating of the emblem EM, and a time for which this state lasts exceeds the threshold value tth, the heating of the emblem EM is stopped. That is, instead of stopping the heating of the emblem EM as soon as the outside temperature T exceeds the upper limit value T2, the state in which the emblem EM is heated is maintained for a while. In that time, all of the snow adhering to the emblem EM melts and runs down. This prevents the snow from remaining on the surface of the emblem EM when the outside temperature T temporarily rises. That is, impairment of the function (hindrance to delivery of full performance) of the radar system 10 can be suppressed. When the outside temperature T is within the predetermined temperature range, falling snow is in a slightly melted state (a state high in moisture content) and is likely to adhere to the emblem EM. When the outside temperature T is lower than the lower limit value T1, on the other hand, falling snow is hardly melted and is not likely to adhere to the emblem EM. That is, in this case, snow that touches the emblem EM immediately falls off the emblem EM without adhering to the emblem EM. The heating of the emblem EM is accordingly stopped as soon as the outside temperature T becomes lower than the lower limit value T1.

The present invention is not limited to the at least one embodiment described above, and various modification examples are adoptable within the scope of the present invention as described below.

### Modification Example 1

For example, the CPU may be configured so as to execute the heating starting program P1 when it is detected that wipers of the vehicle V are in operation and the outside temperature T is within the predetermined temperature range.

### Modification Example 2

In the at least one embodiment described above, the heater system 20 is applied to the radar module 1. However, the heater system 20 may be applied to other sensor modules (for example, an illuminance sensor module for a headlight).

The vehicle V may be an autonomous vehicle.

1. A heater system for a vehicle, comprising:
a temperature sensor configured to detect an outside temperature;
an electric heater configured to heat one of a predetermined portion of an exterior part of a vehicle, the predetermined portion being a portion in which an in-vehicle sensor different from the temperature sensor is placed, or a surrounding portion of the predetermined portion; and
a control device configured to control power to be supplied to the electric heater based on a result of detection by the temperature sensor,
the control device being configured to start power supply to the electric heater when the outside temperature is equal to or higher than a predetermined first temperature and equal to or lower than a second temperature, which is higher than the predetermined first temperature, start, when the outside temperature exceeds the second temperature during the power supply to the electric heater, measurement of a duration time for which the outside temperature remains above the second temperature, and stop the power supply to the electric heater when the duration time exceeds a predetermined threshold value.

2. The heater system for a vehicle according to claim 1,
wherein the electric heater includes a heating wire,
wherein the heating wire is incorporated in a cover member configured to cover the in-vehicle sensor, and
wherein one of a length of time required to melt, with the electric heater, all of adhering snow from a state in which the outside temperature matches the second temperature and snow adheres to an entire surface of the cover member, or a time longer than the required length of time, is set as the predetermined threshold value.

3. The heater system for a vehicle according to claim 2,
wherein the in-vehicle sensor includes antennas configured to transmit and receive radio waves, and
wherein the cover member is transmissive of the radio waves, and is attached to an opening portion formed in the exterior part.

4. A sensor module for a vehicle, comprising the heater system for a vehicle of claim 1.

5. A vehicle, comprising the heater system for a vehicle of claim 1.

6. A vehicle, comprising the heater system for a vehicle of claim 2.
